(19) United States
(12) Patent Application Publication
(10) Pub. No.: US 2022/0148006 A1
(43) Pub. Date: May 12, 2022

(54) IDENTIFICATION PROCESSING APPARATUS, SETTLEMENT TERMINAL, AND SETTLEMENT SYSTEM

(71) Applicant: Glory Ltd., Himeji-shi (JP)

(72) Inventors: Yasunori SHIROURA, Saitama (JP); Shutaro TERAMOTO, Shizuoka (JP); Maki SUZUKI, Tokyo (JP); Hiraku KASAHARA, Tokyo (JP)

(73) Assignee: Glory Ltd., Himeji-shi (JP)

(21) Appl. No.: 17/585,555

(22) Filed: Jan. 27, 2022

Related U.S. Application Data
(63) Continuation of application No. PCT/JP2020/028454, filed on Jul. 22, 2020.

(30) Foreign Application Priority Data
Jul. 31, 2019 (JP) 2019-141490

(51) Int. Cl. G06Q 20/40

(52) U.S. Cl. CPC G06Q 20/40145; G06Q 20/409

(57) ABSTRACT

An identification processing apparatus of the present disclosure includes a memory that stores recognition information based on which an authorized person, who has been authorized to utilize at least part of an account for non-cash settlement, is recognized; an identification circuit configured to acquire an identification request that includes identification information from a settlement terminal installed at a store, and performs an identification process, to identify authorized person, by matching the recognition information with the identification information, the store being where the authorized person purchases a commercial product by utilizing the account; and a communication circuit configured to receive the identification information from the settlement terminal, and transmit a result of the identification to the settlement terminal.

### CROSS-REFERENCE TO RELATED APPLICATIONS

This application is a bypass continuation of International Patent Cooperation Treaty Application No. PCT/JP2020/028454, filed on Jul. 22, 2020, which claims priority to Japanese Patent Application No. 2019-141490, filed on Jul. 31, 2019, the entire disclosures of each are incorporated herein by reference.

### BACKGROUND

There is known a customer transaction system in which a customer efficiently gives cash to a person who cannot perform an account transaction in a financial institution. Further, in recent years, transactions through non-cash settlement (cashless settlement) have been becoming popular in addition to transactions through cash settlement.

### SUMMARY

An identification processing apparatus of the present disclosure includes a memory that stores recognition information based on which an authorized person, who has been authorized to utilize at least part of an account for non-cash settlement, is recognized; an identification circuit configured to acquire an identification request that includes identification information from a settlement terminal installed at a store, and performs an identification process, to identify authorized person, by matching the recognition information with the identification information, the store being where the authorized person purchases a commercial product by utilizing the account; and a communication circuit configured to receive the identification information from the settlement terminal, and transmit a result of the identification to the settlement terminal.

### BRIEF DESCRIPTION OF THE DRAWINGS

FIG. 1 is a diagram a flow of processing in a settlement authority-granting system according to an embodiment of the present disclosure;

FIG. 2 is a sequence diagram illustrating a schematic flow of processing in the settlement authority-granting system;

FIG. 3 is a block diagram illustrating a configuration of the settlement authority-granting system;

FIG. 4 illustrates a flowchart illustrating an authorization processing executed by a user terminal;

FIG. 5 illustrates a flowchart illustrating an identification processing executed by an identification server; and

FIG. 6 is a block diagram of processing circuitry that performs computer-based operations in accordance with the present disclosure.

### DETAILED DESCRIPTION OF THE DRAWINGS

In a case where a certain person makes remittance to another person by using non-cash settlement, both are required to have accounts of the same non-cash settlement service.

Further, even when both have accounts of the same non-cash settlement service, it may be possible to make remittance but it may be difficult to perform dispensing, depending on the service.

Given these circumstances, there is a demand that a certain person wishes to allow another person, who does not have an account of the same non-cash settlement service as that of the certain person, to perform a transaction by using an account of the certain person.

An object of the present disclosure is to provide an identification processing apparatus, a settlement terminal, and a settlement system which enable a person who has an account for non-cash settlement to authorize another person to utilize the account.

A settlement terminal of the present disclosure performs settlement, and comprises: an identification information generating unit that generates identification information that is transmitted to an identification server apparatus that stores recognition information based on which an authorized person who has been authorized to utilize at least part of a predetermined account for non-cash settlement is recognized; a communication unit that transmits an identification request comprising the identification information to the identification server apparatus and receives result information comprising a result of identification of the authorized person, where the identification has been performed by the identification server apparatus by matching the recognition information with the identification information; and a settlement unit that settles, in a case where the result information indicates that the identification of the authorized person is successful, payment for a commercial product, which the authorized person intends to purchase, by using the account.

A settlement system of the present disclosure comprises: a terminal apparatus that generates recognition information based on which an authorized person who has been authorized to utilize at least part of a predetermined account for non-cash settlement is recognized; an identification server apparatus that stores the recognition information transmitted from the terminal apparatus; and a settlement terminal that performs settlement when the authorized person purchases a commercial product by utilizing the account. The settlement terminal transmits an identification request comprising identification information to the identification server apparatus. The identification server apparatus performs identification of the authorized person by matching the recognition information with the identification information, and transmits result information comprising a result of the identification to the settlement terminal. In a case where the result information indicates that the identification of the authorized person is successful, the settlement terminal settles payment for the commercial product by using the account.

According to the present disclosure, a person who has an account for non-cash settlement is capable of authorizing another person to utilize the account.

Hereinafter, an embodiment of the present disclosure will be described in detail with reference to the accompanying drawings. However, a more detailed description than necessary, for example, a detailed description of already well-known matters, a duplicated description of substantially the same configuration, and the like may be omitted.

Note that, the following description and referenced drawings are provided for a person skilled in the art to understand the present disclosure and are not intended to limit the scope of the claims of the present disclosure.

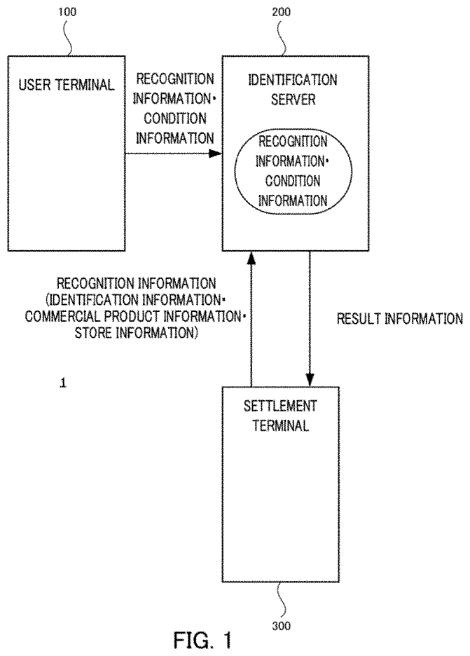

FIG. 1 is a of a settlement system 1 according to an embodiment of the present disclosure. As illustrated in FIG. 1, the settlement system 1 comprises a user terminal 100, an identification server 200, and a settlement terminal 300.

The user terminal 100 is a terminal apparatus that performs processing for a person, who has an account for non-cash settlement, to authorize an another person to utilize the account, or the like. The identification server 200 is a cloud server apparatus that performs identification or the like of a person who has been authorized to utilize an account of a person for non-cash settlement by the person who has the account. The settlement terminal 300 is a terminal apparatus that is installed at a store and performs non-cash settlement processing or the like.

Note that, although one user terminal 100, one identification server 200, and one settlement terminal 300 are depicted in the example illustrated in FIG. 1, respectively, the present disclosure is not limited thereto. The settlement system 1 may comprise a plurality of the user terminals 100, a plurality of the identification servers 200, and a plurality of the settlement terminals 300, respectively.

Note that, the settlement system 1 is an example of the settlement system of the present disclosure. Further, the user terminal 100 is an example of the user terminal of the present disclosure. Further, the identification server 200 is an example of the identification processing apparatus or identification server apparatus of the present disclosure. Further, the settlement terminal 300 is an example of the settlement terminal of the present disclosure.

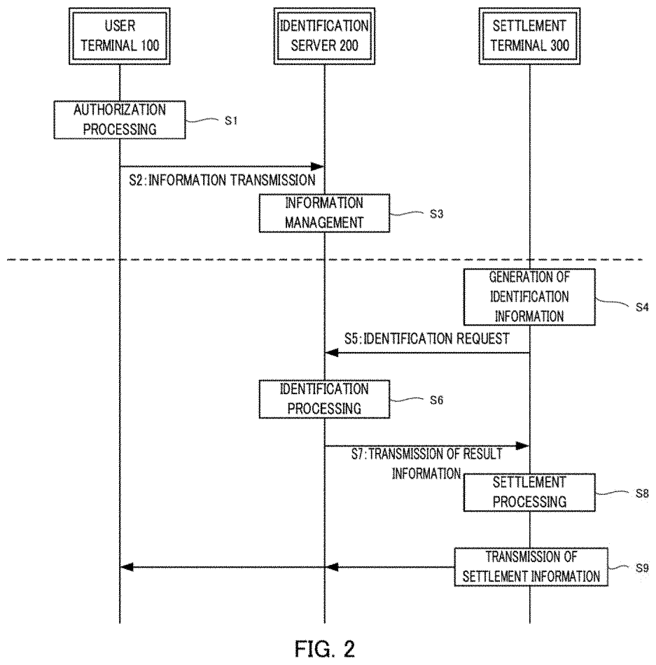

Hereinafter, a schematic flow of processing in the settlement system 1 will be described with reference to FIGS. 1 and 2.

The user terminal 100 is a terminal apparatus comprised by a first user in the settlement system 1. The user terminal 100 is, for example, a portable terminal apparatus such as a smartphone and a tablet terminal.

The first user is an owner of an account for non-cash settlement (cashless settlement). The account for non-cash settlement means a right to receive a non-cash settlement service. In the following description, the account of the first user for non-cash settlement may be referred to simply as “account”.

An application program for the first user to grant at least part of authority to perform settlement by utilizing the account of the first user to an authorized person is installed at the user terminal 100. The authorized person is a person different from the first user, and is an example of the user of the present disclosure. In the following description, the authorized person is described as “second user”.

This application program is configured to be capable of setting various conditions in a case where the first user allows the second user to utilize the account.

In the following description, at least part of the authority to perform settlement by utilizing the account is referred to as “settlement authority”. Further, the application program for granting the settlement authority to the second user is referred to as “user-setting application”. Further, a condition(s) for allowing the second user to utilize the account are referred to as “utilization condition(s)”. Details of utilization conditions will be described later.

In a case where the first user grants the settlement authority to the second user, the first user first operates the user terminal 100 in which the user-setting application is executed, and performs authorization processing of registering the second user as an authorized person (step S1 illustrated in FIG. 2).

At this time, the user terminal 100 in which the user-setting application operates generates recognition information for recognizing the second user, and condition information indicating a utilization condition(s) described above.

The recognition information is arbitrarily selected from any of a plurality of kinds of recognition information. As an example of the kinds of recognition information, it is possible to mention biometric information used for biometric identification of the second user, specifically face image data, voiceprint data, and moving image data in which movements of the body are stored, and the like. Further, as another example, it is possible to mention an identification code (such as a barcode and a two-dimensional code, for example) issued to the second user during the authorization processing. Details of the authorization processing will be described later.

The recognition information and the condition information generated by the user terminal 100 are transmitted to the identification server 200 (step S2).

The identification server 200 stores the recognition information and the condition information, which are transmitted from the user terminal 100, and settlement information to be described later in association with each other (step S3).

The second user to whom the settlement authority has been granted by the first user intends to go to a store and purchase a desired commercial product by using the settlement authority. At this point in time, a clerk of the store does not know whether the person who purchases the commercial product is the second user to whom the settlement authority has been granted, and it is therefore necessary to perform identification of the person who purchases the commercial product.

When the second user purchases the commercial product, the settlement terminal 300 installed at the store generates identification information for causing the identification server 200 to perform identification of the second user (step S4).

The identification information is information for performing the identification of the second user by matching the recognition information described above with the identification information. The identification information corresponds to a kind of the recognition information stored in the identification server 200.

That is, in a case where the recognition information stored in the identification server 200 comprises face image data of the second user, the second user declares to the clerk, who operates the settlement terminal 300, that the second user wishes face identification. Upon receiving this declaration, the clerk operates the settlement terminal 300 to generate face image data of the second user. The settlement terminal 300 then generates identification information comprising the generated face image data.

Further, in a case where the recognition information stored in the identification server 200 comprises an identification code given to the second user, the second user causes the identification code to be displayed on a portable terminal or the like in advance, which is comprised by the second user, and declares to the clerk that the second user wishes identification by means of the identification code. Upon receiving this declaration, the clerk operates the settlement terminal 300 to read the identification code presented by the second user. The settlement terminal 300 then generates identification information comprising the read identification code.

The settlement terminal 300 transmits an identification request for requesting the identification of the second user to the identification server 200 (step S5). The identification request comprises the identification information described above, commercial product information on the commercial product to be purchased by the second user, and store information on the store where the second user purchases the commercial product.

When the identification server 200 receives the identification request from the settlement terminal 300, the identification server 200 performs identification processing of the second user by using the identification information, the commercial product information, and the store information, which are comprised in the identification request, and the recognition information, the condition information, and the settlement information (step S6). Details of the identification processing by the identification server 200 will be described later.

Thereafter, the identification server 200 transmits result information indicating a result of the identification to the settlement terminal 300 (step S7). In a case where the identification is successful, the settlement terminal 300 that has received the result information performs, based on the result information, settlement processing of the commercial product to be purchased by the second user (step S8). In a case where the identification is unsuccessful, the settlement terminal 300 does not perform the settlement processing and displays on a display screen or the like a message or the like that a utilization condition(s) is/are not satisfied.

Existing non-cash settlement techniques can be utilized for the settlement processing by the settlement terminal 300. That is, payment for a commercial product may be withdrawn from an account of a financial institution, electronic money or the like of the first user, which is associated with the account of the first user. Note that, the settlement processing may be performed by the settlement terminal 300 or may be performed by another settlement apparatus (such as a POS (point of sales) register) that operates in cooperation with the settlement terminal 300.

In step S9, the settlement terminal 300 transmits settlement information comprising a result of the settlement processing to the user terminal 100 and the identification server 200. Thus, for example, the settlement information can be displayed at the user terminal 100, and the first user can confirm that the second user has been able to purchase the commercial product. Further, the identification server 200 stores the settlement information in association with the recognition information and the condition information described above.

As described above, in the settlement system 1, the first user is capable of granting at least part of the authority to perform settlement by utilizing the account of the first user for non-cash settlement to the second user. Thus, the second user can purchase a commercial product at a store by utilizing the account of the first user.

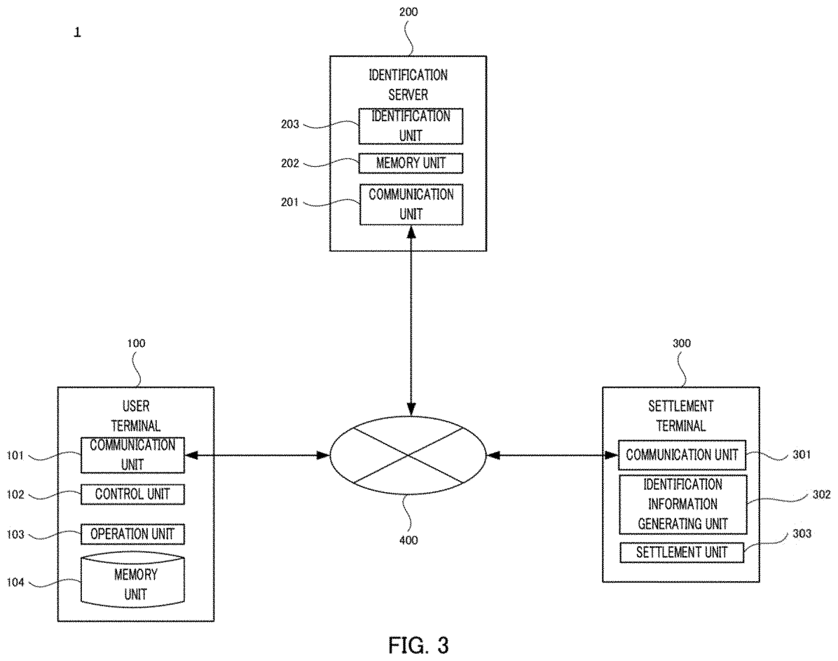

Hereinafter, each configuration of the settlement system 1 will be described with reference to FIG. 3. As illustrated in FIG. 3, in the settlement system 1, the user terminal 100, the identification server 200, and the settlement terminal 300 are connected to each other via a network 400.

Note that, although one user terminal 100, one identification server 200, and one settlement terminal 300 are depicted in the example illustrated in FIG. 3, respectively, the present disclosure is not limited thereto, and the settlement system 1 may comprise a plurality of the user terminals 100, a plurality of the identification servers 200, and a plurality of the settlement terminals 300, respectively, in the same manner as in FIG. 1.

The network 400 may be, for example, a public network such as the Internet, a dedicated network, a network comprising both a public network and a dedicated network, or the like.

As illustrated in FIG. 3, the user terminal 100 comprises a communication unit 101, a control unit 102, an operation unit 103, and a memory unit 104.

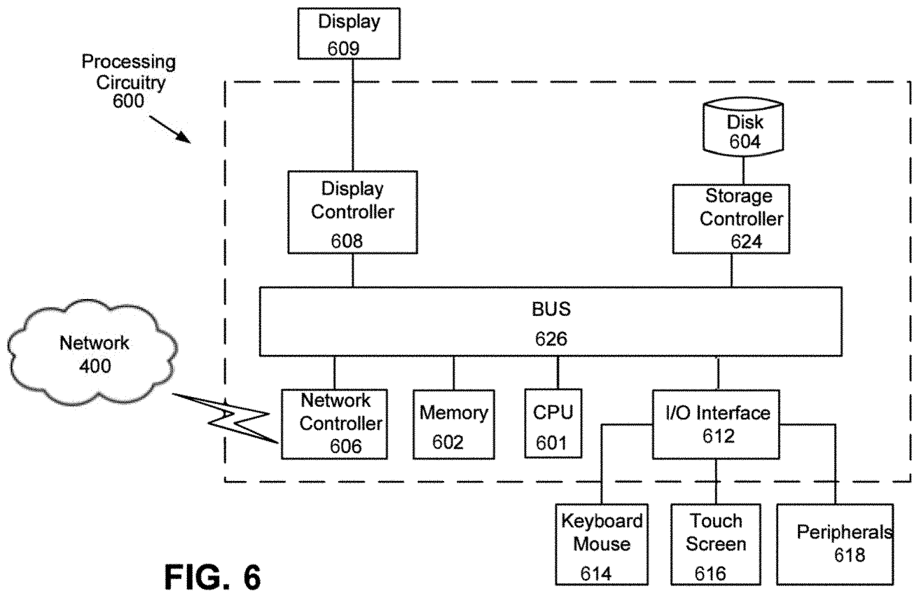

The communication unit 101 is a communication device that transmits and receives various kinds of information via the network 400. The control unit 102 is a control device, such as a processor, that performs the authorization processing by executing the application program (the user-setting application). The processor may also be encompassed by processing circuitry 600 to be discussed later with respect to FIG. 6. In other implementations, communication unit 101, control unit 102, operation unit 103 and memory unit 104 may each include their own respective circuits, circuitry or processing circuitry.

The operation unit 103 is an operation device for receiving an operation of the first user and is, for example, a pointing device such as a touch screen, a keyboard (physical or a digital keyboard), and a stylus. The memory unit 104 is a memory device such as a memory. The control unit 102 reads data, programs and the like stored in the memory unit 104, and performs various kinds of processing.

The identification server 200 comprises a communication unit 201, a memory unit 202, and an identification unit 203.

The communication unit 201 is a communication device that transmits and receives various kinds of information via the network 400.

The memory unit 202 stores recognition information and condition information, which are received from the user terminal 100, and settlement information received from the settlement terminal 300 in association with each other.

In a case where the identification unit 203 receives an identification request from the settlement terminal 300, the identification unit 203 performs identification processing by using recognition information and condition information, and settlement information, which are stored in the memory unit 202, and identification information, commercial product information, and store information, which are comprised in the identification request.

The memory unit 202 and the identification unit 203 are formed of a control device such as a processor. The processor may also be encompassed by processing circuitry 600 to be discussed later with respect to FIG. 6. In other implementations, communication unit 201, memory unit 104 and identification unit 203 may each include their own respective circuits, circuitry or processing circuitry.

The memory unit 202 is a memory device, such as a memory and a magnetic disk apparatus, that stores various kinds of information such as recognition information, condition information, and settlement information. Note that, the memory unit 202 may not be provided inside the identification server 200 or may be provided outside the identification server 200 in a state in which the memory unit 202 is capable of communicating with the other configurations of the identification server 200.

The settlement terminal 300 comprises a communication unit 301, an identification information generating unit 302, and a settlement unit 303.

The communication unit 301 is a communication device that transmits and receives various kinds of information via the network 400.

The identification information generating unit 302 generates identification information for performing identification of the second user who visits a store and purchases a commercial product by utilizing the account of the first user. The settlement unit 303 performs settlement processing based on a result of identification received from the identification server 200.

The identification information generating unit 302 and the settlement unit 303 are formed of a control device such as a processor. The processor may also be encompassed by processing circuitry 600 to be discussed later with respect to FIG. 6. In other implementations, communication unit 301, identification information generation unit 302 and settlement unit 303 may each include their own respective circuits, circuitry or processing circuitry.

Next, each processing executed by each apparatus forming the settlement system 1 will be described in detail.

### Authorization Processing

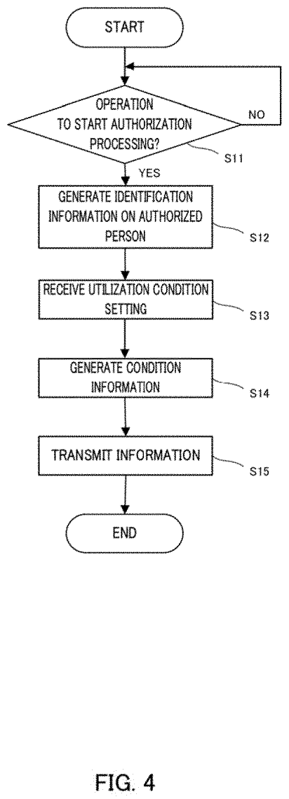

First, the authorization processing executed by the user terminal 100 will be described with reference to FIG. 4. The authorization processing described below is performed by reading and executing, by the control unit 102 of the user terminal 100, of the user-setting application stored in the memory unit 104.

In step S11, the user terminal 100 in which the user-setting application operates determines whether the first user has performed an operation to start the authorization processing on the operation unit 103.

This start operation is, for example, an operation in which the first user touches an icon of the user-setting application. The icon is displayed on a display or the like of the user terminal 100.

In a case where the start operation is performed (step S11: YES), the processing proceeds to step S12. Otherwise (step S11: NO), the processing in step S11 is repeated.

In a case where the user terminal 100 determines that the start operation has been performed, the user terminal 100 generates recognition information on the authorized person (the second user) in step S12. Specifically, the user terminal 100 generates biometric information on the second user as the recognition information, by causing the first user to capture a face image of the second user by using a camera or the like, or by causing the first user to store the voice of the second user by using a microphone or the like.

Alternatively, the user terminal 100 may communicate with a server or the like and acquire a two-dimensional code for being displayed on a second user terminal of the second user to set the two-dimensional code as the recognition information.

In step S13, the user terminal 100 receives an operation of utilization condition setting by the first user. As examples of utilization conditions, it is possible to mention, for example, utilization conditions below.

A first example of the utilization conditions is a condition of an upper limit amount of settlement that can be performed at one time (hereinafter referred to as “upper limit amount (one time)”). For example, when the upper limit amount (one time) is set to 3,000 JPY, the second user can purchase a commercial product up to 3,000 JPY at one time by utilizing the settlement authority.

A second example of the utilization conditions is a condition of a total amount of upper limit amounts of settlements that can be performed (hereinafter referred to as “upper limit amount (total amount)”). For example, when the upper limit amount (total amount) is set to 10,000 JPY, the second user can purchase commercial products with a total amount up to 10,000 JPY when the purchase of the commercial products is made a plurality of times by utilizing the settlement authority.

A third example of the utilization conditions is a condition of an upper limit number of commercial products that can be settled at one time. For example, when the upper limit number of commercial products is set to three, the second user cannot purchase four or more commercial products at one time.

A fourth example of the utilization conditions is a condition of a kind of a commercial product. For example, when chewing gum is set as the kind of the commercial product, the second user cannot purchase a commercial product, for example, chocolate, other than chewing gum by utilizing the settlement authority.

In addition, more specifically, a utilization condition may also be set such that only chewing gum with a commercial product name B of a company A can be purchased, for example. Further, not only a kind of a commercial product, but a commercial product genre (for example, confectionery, stationery, or the like) or a commercial product recognition code such as a JAN (Japanese Article Number) code can also be set as a utilization condition.

A fifth example of the utilization conditions is a condition of a store where the settlement authority can be utilized. For example, when a store C is set, the second user cannot purchase a commercial product at a store other than the store C by utilizing the settlement authority.

A utilization condition may also be set such that a commercial product can be purchased not only at a specific store, but also, for example, solely at a store belonging to a specific chain. Further, a utilization condition may also be set such that a commercial product can be purchased only at a store located at a specific location. For example, when a shopping street D or a building E is set as the location, the second user cannot purchase a commercial product at a store located in a location other than the shopping street D or the building E by utilizing the settlement authority. It may also be configured such that not only a specific location, but a specific area (for example, in a town F, on the premises of a station G, or the like) can also be set.

A sixth example of the utilization conditions is a period during which the settlement authority can be utilized. For example, when the period is set to three days, the second user cannot purchase a commercial product by utilizing the settlement authority on or after the fourth day.

The period is not limited to the number of days, and may be a time unit, a minute unit, a month unit, or a year unit. Alternatively, it may also be configured such that the settlement authority can be utilized only on a specific day (only the day, only January 1, or the like), or only for a specific time zone (only between 15 o'clock and 17 o'clock every day, or the like).

A seventh example of the utilization conditions is an upper limit number of times settlements can be performed. For example, when the upper limit number of times is set to three, the second user cannot purchase commercial products four or more times by utilizing the settlement authority.

An eighth example of the utilization conditions is a condition relating to parental control. In the present embodiment, the utilization condition relating to the parental control is a condition that can be set in a case where the first user is a parent and the second user is his/her child. For example, when the parental control is turned on in a case where the second user (child) intends to make a purchase at a store by using the account of the first user (parent), the terminal (the user terminal 100) of the first user receives a message that the second user intends to make a purchase. At this time, the user terminal 100 may display a screen that allows the first user to select whether to approve the purchase by the second user. In such a case, when the first user selects the approval, settlement is performed by using the account of the first user when the second user makes a purchase, whereas when the first user does not select the approval, the second user cannot make a purchase. When the parental control is not turned on, on the other hand, the first user does not receive a message even in a case where the second user intends to make a purchase by using the account of the first user.

A ninth example of the utilization conditions is a condition relating to a commercial product to be purchased without fail. For example, when soy sauce is set as the commercial product to be purchased without fail, the second user cannot purchase any other commercial product, for example, confectionery, by utilizing the settlement authority unless the second user purchases soy sauce. Note that, in the ninth example of the utilization conditions, payment for a commercial product to be purchased without fail is not comprised in an upper limit amount in a case where the second user uses the settlement authority. This payment is settled, together with payment for a commercial product(s) to be purchased by the second user by utilizing the settlement authority, from the account of the first user. Such a utilization condition enables the second user to make a purchase by utilizing the settlement authority as a reward only in a case where the first user asks the second user to run errands and the second user has completed the errands, for example.

In the examples described above, the case in which the authorized person is one second user has been described, but it may also be configured such that the authorized person is a group formed of a plurality of persons, and that the settlement authority is granted only to a specific number of persons among the group. For example, when a group of six persons are registered as authorized persons and the settlement authority is set to be granted to only three of them, the other three persons cannot utilize the settlement authority.

Further, in addition to the utilization conditions described above, it may also be configured such that an arbitrary condition set by the first user can be set as a utilization condition. Further, it may also be configured such that a plurality of utilization conditions can be combined or only one thereof is set as a utilization condition.

For example, a plurality of utilization conditions may be combined, such as purchase up to 3,000 JPY (upper limit amount) is allowed at a night stall(s) (location, store) provided on the premises of a Shinto shrine H during a day(s) (period) of a festival thereof. In this way, the authority whose uses are limited by the intention of the first user can be flexibly granted.

The description of FIG. 4 will be resumed. In step S14, the user terminal 100 generates condition information indicating the utilization condition(s) set in step S13.

In step S15, the user terminal 100 transmits the recognition information and the condition information to the identification server 200. Thus, the authorization processing is completed.

### Identification Processing

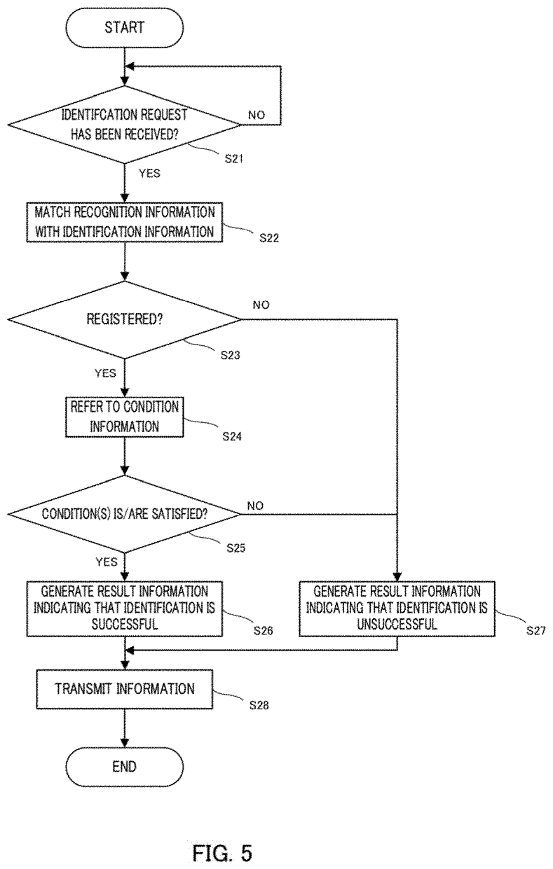

Next, the identification processing executed by the identification server 200 will be described with reference to FIG. 5.

In step S21, the identification unit 203 of the identification server 200 determines whether an identification request has been received from the settlement terminal 300 via the communication unit 201. In a case where the identification unit 203 determines that an identification request has been received (step S21: YES), the processing proceeds to step S22. Otherwise, the processing in step S21 is repeated.

In step S22, the identification unit 203 matches identification information comprised in the identification request received in step S21 with recognition information stored in the memory unit 202.

In step S23, the identification unit 203 determines, based on a result of the matching, whether recognition information indicating the person (that is, the second user who purchases a commercial product at a store) indicated by the identification information has been registered in the identification server 200.

In a case where the identification unit 203 determines that the recognition information for recognizing the person indicated by the identification information has been registered in the identification server 200 (step S23: YES), the processing proceeds to step S24. Otherwise (step S23: NO), the processing proceeds to step S27.

In step S24, the identification unit 203 refers to condition information stored in the memory unit 202. In step S25, the identification unit 203 determines whether the utilization condition(s) comprised in the condition information is/are satisfied.

The condition information may comprise various utilization conditions as in the first to ninth examples described above. In the various utilization conditions that may be comprised in the condition information, there are those which require matching with commercial product information or store information, and those which do not require the above.

In the first to ninth examples described above, the first example (upper limit amount (one time)), the second example (upper limit amount (total amount)), the third example (upper limit number of commercial products), the fourth example (specific commercial product), the fifth example (specific store, location), and the ninth example (commercial product to be purchased without fail) are examples of the utilization conditions that require matching with commercial product information or store information.

With respect to the utilization conditions that require matching with commercial product information or store information as described above, the identification unit 203 matches commercial product information and store information, which are comprised in an identification request, with the utilization condition(s), and determines whether the utilization condition(s) is/are satisfied.

On the other hand, the sixth example (period), the seventh example (upper limit number of times) and the eighth example (parental control) among the first to ninth examples described above do not require matching with commercial product information or store information.

For example, in a case where a specific period is set as a utilization condition, the identification unit 203 determines, based on information on a point in time when the second user intends to purchase a commercial product, whether the utilization condition is satisfied. For example, the identification unit 203 may acquire time-related information from a clock function comprised by the identification server 200, an external time server or the like to thereby determine whether the utilization condition is satisfied. Note that, the information on the point in time when the second user intends to purchase a commercial product comprise, for example, information on a time when identification information is generated by the settlement terminal 300, a time when the communication unit 201 receives identification information, or the like.

Further, for example, in a case where an upper limit number of times is set as a utilization condition, the identification unit 203 refers to settlement information stored in the memory unit 202 to thereby determine whether the number of times the second user has made a purchase satisfies the utilization condition.

In a case where the identification unit 203 determines that the utilization condition(s) is/are satisfied (step S25: YES), the processing proceeds to step S26. Otherwise (step S25: NO), the processing proceeds to step S27.

In step S26, the identification unit 203 generates result information indicating that the identification is successful. In step S27, on the other hand, the identification unit 203 generates result information indicating that the identification is unsuccessful.

In step S28, the identification unit 203 transmits the result information to the settlement terminal 300. Thus, the identification processing is completed.

The configuration and operations of the settlement system 1 according to the embodiment of the present disclosure have been described thus far. Hereinafter, Operation Examples 1 to 3 below will be described as more detailed use examples of the settlement system 1.

### Operation Example 1

As Operation Example 1, a case where a parent grants the settlement authority to his/her child will be described.

The parent who is the first user having an account for non-cash settlement. Further, the parent has the user terminal 100 described above. It is assumed, on the other hand, that the child who is the second user does not have an account for non-cash settlement and does not have a terminal apparatus such as the user terminal 100 either.

It is assumed that the parent intends to grant, as an allowance, the settlement authority up to 3,000 JPY per month utilizing the account of the parent to the child. In such a case, the parent operates the user terminal 100 to start the user-setting application and registers the child as an authorized person (corresponding to step S1 illustrated in FIG. 2).

Although the registration method is not particularly limited in the present disclosure, the following method can be adopted, for example.

A button or the like, which is operated when an authorized person is registered, is displayed on an operation screen of the user-setting application. The parent operates the button so that the screen transitions to a screen for selecting a means for registering an authorized person.

As examples of the means for registering an authorized person, it is possible to mention face image registration, voice registration, fingerprint registration, iris registration, or the like as biometric identification. Note that, although the example in which the parent can select a means for registering an authorized person from among a plurality of means has been indicated here, it may also be configured such that the registration of an authorized person is received only by any one method.

In the following description, it is assumed that face image registration has been selected by the parent. In this case, the parent captures a face image of the child by using a camera of the user terminal 100 or the like.

Next, the screen of the user-setting application transitions to a screen for utilization condition registration. On this screen, the parent sets utilization conditions such that the upper limit amount (total amount) is 3,000 JPY and the period is one month. The parent may further set other conditions.

In this Operation Example 1, it is assumed that, in addition to setting the upper limit amount (total amount) described above to 3,000 JPY, the amount that the child can use at one time (upper limit amount (one time)) is set to 500 JPY, and confectionery, books, stationery, and the like are set as commercial products genres, and a store in a town where the parent resides is set as a specific store.

When the registration of the face image of the child and the utilization conditions is completed in this way, the user terminal 100 in which the user-setting application operates generates recognition information and condition information, and transmits the recognition information and the condition information to the identification server 200 (corresponding to step S2 in FIG. 2).

The identification server 200 stores the received recognition information and condition information in association with each other (corresponding to step S3 of FIG. 2). This means that part of the settlement authority of the account of the parent has been granted to the child.

Thereafter, it is assumed that the child intends to go to the store and purchase a commercial product. At that time, the child informs a clerk who operates the settlement terminal 300 of the store that the child purchases the commercial product by utilizing the account of the parent, and that the child wishes identification by means of the face image.

The clerk then captures a face image of the child by using a camera of the settlement terminal 300 or the like. The settlement terminal 300 generates identification information based on the captured face image (corresponding to step S4 in FIG. 2).

Then, the clerk causes the settlement terminal 300 to acquire commercial product information on the commercial product that the child intends to purchase. The commercial product information comprises the commercial product name, manufacturer, JAN code, price, and the like of chewing gum.

For example, the clerk uses a barcode reader or the like to read a barcode described in packaging of the chewing gum and refers to commercial product master information or the like of a server of the store so that the settlement terminal 300 acquires the commercial product information.

The settlement terminal 300 transmits an identification request comprising, in addition to the identification information generated based on the captured face image of the child and the acquired commercial product information, store information on the store to the identification server 200 (corresponding to step S5 in FIG. 2).

The store information is, for example, information on the store registered in the settlement terminal 300 in advance. The store information comprises information such as the store name, the name of a chain to which the store belongs, the place (address) of the store, and the like.

The identification server 200 that has received the identification request performs identification processing by referring to the identification information, the commercial product information, and the store information, which are comprised in the identification request, and the recognition information and the condition information, which are stored in the identification server 200 (corresponding to step S6 in FIG. 2).

Specifically, the identification server 200 extracts, from the recognition information stored in the identification server 200, recognition information indicating the person (the child who purchases the commercial product at the store) indicated by the identification information. In a case where there is no recognition information indicating the person indicated by the identification information in the recognition information stored in the identification server 200, the identification server 200 determines that the identification is unsuccessful.

In a case where there is recognition information indicating the person indicated by the identification information in the recognition information stored in the identification server 200, the identification server 200 matches the condition information associated with the extracted recognition information with the commercial product information and the store information, and determines whether the utilization conditions set in advance are satisfied. In a case where the utilization conditions set in advance are satisfied, the identification server 200 determines that identification is successful.

In this Operation Example 1, the face image of the child is stored as recognition information in the identification server 200 as described above so that the identification server 200 can extract the recognition information that agrees with the identification information generated by the settlement terminal 300.

Whether the utilization conditions comprised in the condition information are satisfied depends on what the child intends to purchase and at which store. For example, in a case where the child intends to purchase chewing gum of 120 JPY at a supermarket in the town where the parent resides and the total amount of utilization is less than 3,000 JPY, all the utilization conditions set by the parent in this Operation Example 1 are satisfied. Accordingly, in such a case, the identification server 200 determines that the identification is successful.

On the other hand, the utilization conditions are not partially satisfied in a case where the child intends to purchase a commercial product at a convenience store in a neighboring town, in a case where the child intends to purchase a book of 600 JPY, in a case where the total amount of purchase this time exceeds 3,000 JPY, in a case where the child intends to purchase a battery (or batteries) of 300 JPY, or the like. Accordingly, in such a case, the identification server 200 determines that the identification is unsuccessful.

The identification server 200 generates result information based on a result of the identification, and transmits the result information to the settlement terminal 300 (corresponding to step S7 in FIG. 2). In a case where the result information indicates that the identification is successful, the settlement terminal 300 performs settlement processing of the commercial product, which the child intends to purchase, from the account of the parent (corresponding to step S8 in FIG. 2).

In a case where the result information indicates that the identification is unsuccessful, on the other hand, the settlement terminal 300 does not perform settlement processing and displays on the display screen or the like that the utilization conditions are not satisfied.

When the settlement processing by the settlement terminal 300 is completed, the settlement terminal 300 generates settlement information comprising the name, commercial product genre, and amount of the commercial product purchased by the child, the name and location of the store where the child has purchased the commercial product, and the like, and transmits the settlement information to the user terminal 100 and the identification server 200 (corresponding to step S9 in FIG. 2).

Thus, the user terminal 100 displays information on the commercial product purchased by the child, the location of the store where the child has purchased the commercial product, and the like so that the parent can manage the purchase by the child.

Further, the identification server 200 stores the settlement information in association with the recognition information and the condition information on the child. Thus, when the child intends to purchase a commercial product next time or thereafter, the identification server 200 is capable of determining whether the utilization conditions such as the upper limit amount (total amount) and the upper limit number of times are satisfied.

According to Operation Example 1 as described above, the parent is capable of granting part of the settlement authority of his/her own account to the child only by initially registering the child as an authorized person.

Thus, the child does not need to carry cash, which is safe. In addition, since the child does not need to have an account, labor for the utilization can be small. Further, it is possible to prevent the child from making an improper purchase by proper utilization condition setting.

Further, since the user terminal 100 receives settlement information in a case where the child makes a purchase, the parent is capable of managing the purchase by the child. Since the child can purchase a commercial product that satisfies a utilization condition(s) when the child goes to a store without carrying cash, the child can easily make a purchase by utilizing the settlement authority of the account of the parent.

Note that, although the example in which the parent grants the settlement authority to the child has been described in Operation Example 1, it may also be configured, for example, such that a specific person responsible for housekeeping in one family grants the settlement authority to all the other family member(s). According to such a use example, it is possible to centrally manage housekeeping.

### Operation Example 2

In Operation Example 1 described above, the case where the identification of the child who is the authorized person is performed by using the face image has been described. In Operation Example 2 below, a case where an identification code such as a two-dimensional code is used for identification of a child will be described.

In the same manner as in Operation Example 1, a parent has an account for non-cash settlement and has the user terminal 100. In this Operation Example 2, on the other hand, it is assumed that his/her child who is the second user does not have an account for non-cash settlement, but has a portable terminal apparatus (hereinafter referred to as “second user terminal”).

In this Operation Example 2, the user terminal 100 in which the user-setting application operates issues an identification code for performing identification of the child in the authorization processing. The identification code issued by the user terminal 100 is transmitted to the second user terminal of the child via a communication network such as the Internet.

Note that, in order to enhance security, it may be configured such that an identification code is not issued by the user terminal 100, but by an external identification server or the like. Further, it may also be configured such that the identification server does not transmit a generated identification code directly to the second user terminal, but transmits an URL for accessing the identification server to the second user terminal.

Then the user terminal 100 transmits recognition information comprising the issued identification code and condition information on a utilization condition(s) set by the parent to the identification server 200. In the same manner as in Operation Example 1, the identification server 200 stores the recognition information and the condition information in association with each other.

Thereafter, it is assumed that the child intends to go to a store and purchase a commercial product. At this time, the child causes the identification code to be displayed on a display screen of the second user terminal. In a case where an URL for accessing an external identification server is transmitted to the second user terminal in the authorization processing, the child accesses the external identification server by operating the second user terminal, causes the external identification server to issue an identification code, and causes the issued identification code to be displayed on the display screen.

A clerk uses an identification code reader of the settlement terminal 300 to read the identification code displayed on the second user terminal. The settlement terminal 300 generates identification information comprising information on the read identification code. The clerk then causes the settlement terminal 300 to acquire commercial product information on the commercial product that the child intends to purchase.

The settlement terminal 300 transmits an identification request comprising, in addition to the generated identification information and the acquired commercial product information, store information on the store to the identification server 200.

The identification server 200 that has received the identification request refers to the identification information, the commercial product information, and the store information, which are comprised in the identification request, and the recognition information and the condition information, which are stored in the identification server 200, to perform the identification processing. At this time, the identification server 200 extracts, based on information on the identification code comprised in the identification information, recognition information comprising an identification code that agrees with the identification code.

The identification server 200 generates result information based on a result of the identification and transmits the result information to the settlement terminal 300. Since subsequent operations are the same as those in Operation Example 1, a description thereof will be omitted.

According to Operation Example 2 as described above, as in Operation Example 1, the parent is capable of easily granting part of the settlement authority of his/her own account to the child so that the child does not need to carry cash, which is safe.

Note that, in Operation Example 2 described above, it is assumed that a two-dimensional code is used as the identification code, but the present disclosure is not limited thereto. For example, a barcode, a one-time password, a personal identification number (PIN) code, or the like may be employed as the identification code.

### Operation Example 3

In Operation Example 3, a case in which the first user is a manager of a certain store and the second user (an authorized person) is a customer of the store will be described. That is, it is assumed that there is a plurality of the second users.

It is assumed that at the certain store, the manager intends to make a reduction for a customer, who makes a purchase, in accordance with the amount of a purchase. In such a case, the manager or an employee of the store (hereinafter simply referred to as “clerk”) performs the authorization processing for the customer by using the user terminal 100 installed at the store.

Note that, although the user terminal 100 and the settlement terminal 300 appear separately for convenience in the following description, the user terminal 100 and the settlement terminal 300 may be integrally configured.

Specifically, when a customer H makes a purchase, the clerk informs the customer H that a coupon usable for the next or subsequent purchase can be issued when a face image of the customer H is registered. In a case where the customer H approves the registration of his/her face image, the clerk captures a face image of the customer H by using the user terminal 100.

Then the clerk sets, as a utilization condition, the store where the clerk works. Recognition information comprising the face image of the customer H and condition information comprising the set utilization condition are transmitted to the identification server 200 and are stored therein. Further, at this time, the user terminal 100 sets a coupon inventory amount in accordance with the amount of the purchase made by the customer H and stores the coupon inventory amount in the settlement terminal 300.

When the customer H visits the store and purchases a commercial product next time, the customer H informs the clerk that the customer H possesses the coupon. The clerk then captures a face image of the customer H by using the camera of the settlement terminal 300 or the like, and transmits an identification request comprising identification information generated based on the face image and store information to the identification server 200.

In this Operation Example 3, commercial product information may not be comprised in the identification request. Alternatively, in a case where the coupon covers only commercial products of a specific genre, for example, commercial product information on the commercial product to be purchased by the customer H may be comprised in the identification request.

When the identification processing is performed by the identification server 200 and result information indicating that the identification is successful is transmitted to the settlement terminal 300, the settlement terminal 300 presents an amount, which is obtained by subtracting the coupon inventory amount from the price of the commercial product purchased by the customer H, to the customer H. Thus, customer H can receive a discount in accordance with the amount of the purchase to be made by the customer H previously.

According to Operation Example 3 as such, a customer does not need to carry, for example, a point card, a coupon, a voucher or the like issued by a store and can receive a discount service in accordance with the amount of a purchase made by the customer previously.

Note that, in the description of Operation Example 3 above, the manager of the store as the first user grants the settlement authority of the account of the manager to a customer, but the amount for a coupon is not actually settled from the account of the manager. Coupon inventory amounts for each customer are stored in the settlement terminal 300, and when a customer purchases a commercial product, the amount for a coupon is only subtracted from the inventory amount. However, the present disclosure is not limited thereto. For example, it may also be configured such that the settlement terminal 300 does not store any coupon inventory amount and that a coupon inventory amount may be set as one utilization condition. In such a case, in a case where a customer intends to purchase a commercial product, the settlement terminal 300 generates identification information and causes the identification server 200 to perform the identification processing based on the utilization condition relating to a coupon inventory amount. Then it may also be configured such that when the identification is successful, the settlement terminal 300 settles the amount for the coupon from the account of the manager.

### Effects

As described above, the settlement system 1 according to the embodiment of the present disclosure comprises: the user terminal 100 that generates recognition information based on which the second user (the authorized person) who is allowed to utilize a predetermined account for non-cash settlement is recognized; the identification server 200 that stores the recognition information transmitted from the user terminal 100; and the settlement terminal 300 that performs settlement when the second user purchases a commercial product by utilizing the account. The settlement terminal 300 transmits an identification request comprising identification information to the identification server 200. The identification server 200 performs identification of the second user by matching the recognition information with the identification information, and transmits result information comprising a result of the identification to the settlement terminal 300. In a case where the result information indicates that the identification of the second user is successful, the settlement terminal 300 settles payment for the commercial product by using the predetermined account.

The settlement system 1 according to the embodiment of the present disclosure enables the first user who has an account for non-cash settlement to authorize the second user to utilize the account with a simple operation.

In addition, it is highly convenient since the second user may not have an account for non-cash settlement. Further, since the first user is capable of arbitrarily setting a utilization condition(s) when the second user utilizes the account, the first user is capable of easily managing the purchase by the second user.

In the settlement system 1 according to the embodiment of the present disclosure, the identification information for performing identification of the second user can be configured to be biometric information comprising face image data, voice data, and the like of the second user.

Accordingly, the settlement system 1 according to the embodiment of the present disclosure enables the second user to perform settlement by utilizing the account even when the second user goes to a store without carrying cash, which is extremely highly convenient.

Further, in the settlement system 1 according to the embodiment of the present disclosure, the identification information for performing identification of the second user can be configured to be an identification code (such as a two-dimensional barcode, a one-time password, and a PIN code) issued to the second user. In a case where such a configuration is employed, high security can be ensured.

### Modifications

The embodiment of the present disclosure has been described thus far, but the present disclosure is not limited to the embodiment described above and can be implemented by appropriately modifying the present disclosure within a scope not departing from the gist of the present disclosure.

In the embodiment described above, the identification server 200 continues to store the recognition information used for identification of the second user even after utilization of the settlement authority by the second user ends. However, in particular in a case where the recognition information is biometric information on the second user, the identification server 200 may not continue to store the recognition information from the viewpoint of security.

In such a case, the identification server 200 may automatically discard at least recognition information on the second user after utilization of the settlement authority by the second user is completed or after a predetermined period has elapsed since the registration of the settlement authority for the second user is performed, for example.

In the embodiment described above, during the identification processing, the identification server 200 performs identification based on recognition information, condition information indicating a utilization condition(s), and settlement information, which are stored in the identification server 200, and identification information, commercial product information, and store information, which are comprised in an identification request from the settlement terminal 300.

However, the identification may be performed without using at least one of settlement information, commercial product information, and store information, depending on a utilization condition(s). For example, in a case where only a period is set as a utilization condition, the identification server 200 may perform the identification based only on recognition information, identification information, and time-related information.

In the embodiment described above, the identification server 200 performs the identification of the second user, but the present disclosure is not limited thereto. That is, when the second user purchases a commercial product at a store by using the account of the first user, the settlement terminal 300 may acquire recognition information on the second user from the identification server 200, and the settlement terminal 300 may perform the identification of the second user.

In the embodiment described above, when the second user purchases a commercial product at a store, the settlement terminal 300 transmits settlement information to the user terminal 100 of the first user as in step S9 of FIG. 2. Thus, the first user is able to know that the second user has been able to purchase the commercial product. In the present disclosure, the following processing may be performed as another example instead of the transmission of settlement information to the user terminal 100 by the settlement terminal 300 after the completion of settlement. That is, for example, before or after the identification server 200 performs the identification processing after receipt of an identification request from the settlement terminal 300, the identification server 200 may notify the user terminal 100 that the identification server 200 has received the identification request relating to the second user. Thus, it is possible for the first user to know that the second user intends to purchase a commercial product by using the account of the first user.

In the embodiment described above, when the second user intends to purchase a commercial product by using the account of the first user, the second user declares a kind of recognition information on the second user generated during the authorization processing to a clerk of a store, but the present disclosure is not limited thereto. As another example, when the second user intends to purchase a commercial product by using the account of the first user, for example, the second user may declare that the second user uses the account of the first user. In such a case, the clerk of the store operates the settlement terminal 300 to notify the identification server 200 that the user (the second user) other than the first user intends to purchase the commercial product by using the account of the first user. The identification server 200 that has been notified refers to recognition information and condition information, which are stored in the identification server 200, and notifies the settlement terminal 300 of the kind of the recognition information on the second user associated with the account of the first user. Thus, the clerk is able to know what kind of identification information should be generated.

FIG. 6 is a block diagram of processing circuitry that performs computer-based operations in accordance with the present disclosure. FIG. 6 illustrates processing circuitry 600 of user terminal 100, identification server 200 and/or settlement terminal 300.

Processing circuitry 600 is used to control any computer-based and cloud-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The functionality of the elements disclosed herein may be implemented using circuitry or processing circuitry which may include general purpose processors, special purpose processors, integrated circuits, ASICs (“Application Specific Integrated Circuits”), conventional circuitry and/or combinations thereof which are configured or programmed to perform the disclosed functionality. Processors are processing circuitry or circuitry as they include transistors and other circuitry therein. The processor may be a programmed processor which executes a program stored in a memory. In the disclosure, the processing circuitry, units, or means are hardware that carry out or are programmed to perform the recited functionality. The hardware may be any hardware disclosed herein or otherwise known which is programmed or configured to carry out the recited functionality.

In FIG. 6, the processing circuitry 600 includes a CPU 601 which performs one or more of the control processes discussed in this disclosure. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other non-transitory computer readable medium of an information processing device with which the processing circuitry 600 communicates, such as a server or computer. The processes may also be stored in network based storage, cloud-based storage or other mobile accessible storage and executable by processing circuitry 600.

Further, the claimed advancements may be provided as a utility application, background daemon, or component of an operating system, or combination thereof, executing in conjunction with CPU 601 and an operating system such as Microsoft Windows, UNIX, Solaris, LINUX, Apple MAC-OS, Apple iOS and other systems known to those skilled in the art.

The hardware elements in order to achieve the processing circuitry 600 may be realized by various circuitry elements. Further, each of the functions of the above described embodiments may be implemented by circuitry, which includes one or more processing circuits. A processing circuit includes a particularly programmed processor, for example, processor (CPU) 601, as shown in FIG. 6. A processing circuit also includes devices such as an application specific integrated circuit (ASIC) and conventional circuit components arranged to perform the recited functions.

In FIG. 6, the processing circuitry 600 may be a computer or a particular, special-purpose machine. Processing circuitry 600 is programmed to execute processing of user terminal 100, identification server 200 and/or settlement terminal 300.

Alternatively, or additionally, the CPU 601 may be implemented on an FPGA, ASIC, PLD or using discrete logic circuits, as one of ordinary skill in the art would recognize. Further, CPU 601 may be implemented as multiple processors cooperatively working in parallel to perform the instructions of the inventive processes described above.

The processing circuitry 600 in FIG. 6 also includes a network controller 606, such as an Ethernet PRO network interface card, for interfacing with network 400. As can be appreciated, the network 400 can be a public network, such as the Internet, or a private network such as a local area network (LAN) or wide area network (WAN), or any combination thereof and can also include Public Switched Telephone Network (PSTN) or Integrated Services Digital Network (ISDN) sub-networks. The network 400 can also be wired, such as an Ethernet network, universal serial bus (USB) cable, or can be wireless such as a cellular network including EDGE, 3G and 4G wireless cellular systems. The wireless network can also be Wi-Fi, wireless LAN, Bluetooth, or any other wireless form of communication that is known. Additionally, network controller 606 may be compliant with other direct communication standards, such as Bluetooth, a near field communication (NFC), infrared ray or other.

The processing circuitry 600 further includes a display controller 608, such as a graphics card or graphics adaptor for interfacing with display 609, such as a monitor. An I/O interface 612 interfaces with a keyboard and/or mouse 614 as well as a touch screen panel 616 on or separate from display 609. I/O interface 612 also connects to a variety of peripherals 618.

The storage controller 624 connects the storage medium disk 604 with communication bus 626, which may be an ISA, EISA, VESA, PCI, or similar, for interconnecting all of the components of the processing circuitry 600. A description of the general features and functionality of the display 609, keyboard and/or mouse 614, as well as the display controller 608, storage controller 624, network controller 606, and I/O interface 612 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

### REFERENCE SIGNS LIST

1 Settlement system
100 User terminal
101 Communication unit
102 Control unit
103 Operation unit
104 Memory unit
200 Identification server
201 Communication unit
202 Memory unit
203 Identification unit
300 Settlement terminal
301 Communication unit
302 Identification information generating unit
303 Settlement unit
400 Network
600 Processing circuitry

1. An identification processing apparatus, comprising:
a memory that stores recognition information based on which an authorized person, who has been authorized to utilize at least part of an account for non-cash settlement, is recognized;
an identification circuit configured to
acquire an identification request that includes identification information from a settlement terminal installed at a store, and
performs an identification process, to identify authorized person, by matching the recognition information with the identification information, the store being where the authorized person purchases a commercial product by utilizing the account; and
a communication circuit configured to
receive the identification information from the settlement terminal, and
transmit a result of the identification to the settlement terminal.

2. The identification processing apparatus according to claim 1, wherein the authorized person is different from an owner of the account.

3. The identification processing apparatus according to claim 1, wherein the recognition information and the identification information comprise biometric information on the authorized person.

4. The identification processing apparatus according to claim 1, wherein the recognition information and the identification information comprise information on an identification code issued to the authorized person.

5. The identification processing apparatus according to claim 1, wherein
the memory stores condition information and the identification information in association with each other, and
the condition information comprises a utilization condition in a case that the authorized person utilizes the account.

6. The identification processing apparatus according to claim 5, wherein
in a case that the condition information comprises information on a commercial product that is purchasable by the authorized person, the identification circuit is configured to
receive commercial product information together with the identification information from the settlement terminal, and
perform the identification process to identify the authorized person based on the recognition information, the condition information, the identification information and the commercial product information, and
the commercial product information comprises information on the commercial product to be purchased by the authorized person.

7. The identification processing apparatus according to claim 5, wherein
in a case that the condition information comprises information on a store where the authorized person is allowed to purchase the commercial product, the identification circuit is configured to
receive store information together with the identification information from the settlement terminal, and
perform the identification process to identify the authorized person based on the recognition information, the condition information, the identification information, and the store information, and
the store information comprises information on the store where the authorized person purchases the commercial product.

8. The identification processing apparatus according to claim 5, wherein
in a case that the condition information comprises information on a period during which the authorized person is allowed to purchase the commercial product, the identification circuit is further configured to perform the identification process to identify the authorized person based on the recognition information, the condition information, the identification information, and information from the settlement terminal, and
the information from the settlement terminal being information on a point in time that the authorized person purchases the commercial product.

9. The identification processing apparatus according to claim 5, wherein
in a case that the authorized person performs settlement by utilizing the account,
the communication circuit receives settlement information on the settlement from the settlement terminal, the settlement information being generated by the settlement terminal, and
the memory stores the settlement information, the identification information, and the condition information in association with each other, and
in a case that the condition information comprises information on a number of times the authorized person is allowed to purchase the commercial product, the identification circuit performs the identification process to identify the authorized person based on the recognition information, the condition information, the identification information, and the settlement information.

10. A settlement terminal that performs settlement, the settlement terminal comprising:
an identification information generating circuit configured to generate identification information;
a communication circuit configured to
transmit an identification request comprising the identification information to an identification server apparatus, the identification server apparatus storing recognition information based on which an authorized person, who has been authorized to utilize at least part of an account for non-cash settlement, is recognized, and
receive result information comprising a result of an identification process to identify the authorized person, the identification process having been performed by the identification server apparatus by matching the recognition information with the identification information; and
a settlement circuit configured to settle, utilizing the account and in a case that the result information indicates that the identification of the authorized person is successful, payment for a commercial product for purchase by the authorized person.

11. The settlement terminal according to claim 10, wherein the authorized person is different from an owner of the account.

12. The settlement terminal according to claim 10, wherein the recognition information and the identification information comprise biometric information on the authorized person.

13. The settlement terminal according to claim 10, wherein the recognition information and the identification information comprise information on an identification code issued to the authorized person.

14. The settlement terminal according to claim 10, wherein
the communication circuit is further configured to transmit commercial product information together with the identification information to the identification server apparatus,
the identification server apparatus performs the identification process based on the recognition information, the condition information, the identification information and the commercial product information, and
the commercial product information comprises information on the commercial product to be purchased by the authorized person.

15. The settlement terminal according to claim 10, wherein
the communication circuit is further configured to transmit store information together with the identification information to the identification server apparatus,
the identification server apparatus performs the identification process based on the recognition information, the condition information, the identification information, and the store information, and
the store information comprises information on the store where the authorized person purchases the commercial product.

16. The settlement terminal according to claim 10, wherein
the communication circuit is further configured to transmit information, on a period during which the authorized person is allowed to purchase the commercial product, to the identification server apparatus,
the identification server apparatus performs the identification process based on the recognition information, the condition information, the identification information, and the information, and
the information indicates a point in time at which the authorized person purchases the commercial product.

17. The settlement terminal according to claim 10, wherein in a case that the authorized person performs settlement by utilizing the account, the communication circuit transmits settlement information to the identification server apparatus, the settlement information being generated by the settlement terminal.

18. A settlement system, comprising:
a terminal apparatus that generates recognition information based on which an authorized person, who has been authorized to utilize at least part of an account for non-cash settlement, is recognized;
an identification server apparatus that stores the recognition information transmitted from the terminal apparatus; and
a settlement terminal that performs settlement in a case that the authorized person purchases a commercial product by utilizing the account, the settlement terminal transmitting an identification request comprising identification information to the identification server apparatus, wherein
the identification server apparatus performs identification process, to identify the authorized person, by matching the recognition information with the identification information, and transmits result information, comprising a result of the identification process to, the settlement terminal, and
in a case that the result information indicates that the identification of the authorized person is successful, the settlement terminal settles payment for the commercial product by utilizing the account.

19. The settlement system according to claim 18, wherein
the identification server apparatus stores condition information and the identification information in association with each other, and
the condition information comprises a utilization condition in a case that the authorized person utilizes the account.

20. The settlement system according to claim 19, wherein
in a case that the condition information comprises information on a commercial product that is purchasable by the authorized person, the identification server apparatus is configured to
receive commercial product information together with the identification information from the settlement terminal, and
perform the identification process to identify the authorized person based on the recognition information, the condition information, the identification information and the commercial product information, and
the commercial product information comprising information on the commercial product to be purchased by the authorized person.
